(19) United States
(12) Patent Application Publication
(10) Pub. No.: US 2019/0021499 A1
(43) Pub. Date: Jan. 24, 2019

(54) OVERTURN PREVENTING DEVICE

(71) Applicant: KYB CORPORATION, Minato-ku, Tokyo (JP)

(72) Inventors: Masakazu NAKAZATO, Minato-ku, Tokyo (JP); Keita ABE, Minato-ku, Tokyo (JP); Atsushi TOYOUCHI, Minato-ku, Tokyo (JP)

(73) Assignee: KYB CORPORATION, Minato-ku, Tokyo (JP)

(21) Appl. No.: 16/069,292

(22) PCT Filed: Feb. 20, 2017
(86) PCT No.: PCT/JP2017/006208

§ 371 Date: Jul. 11, 2018

(30) Foreign Application Priority Data
Mar. 3, 2016 (JP) 2016-040661

(51) Int. Cl. A47B 97/00; F16F 9/06

(52) U.S. Cl. CPC A47B 97/00; F16F 9/516; A47B 2097/008; F16F 9/061

(57) ABSTRACT

Providing an overturn preventing device which can prevent an article from overturn while maintaining the mounted state against an earthquake or the like with multidirectional shaking. The overturn preventing device includes a damper and a pair of a first base and a second base. The damper is mounted between a top surface of a piece of furniture installed on a floor and a ceiling. Two ends of the damper are respectively coupled to the first and second bases so as to be swingable in multiple directions. The first base abuts against the top surface of the furniture and the second base abuts against the ceiling.

### TECHNICAL FIELD

The present invention relates to an overturn preventing device.

### BACKGROUND ART

Patent Document 1 discloses a conventional overturn preventing device. This overturn preventing device includes a damper and a pair of bases. The damper is mounted between a top surface of a piece of furniture installed on a floor and a ceiling. The damper has two ends respectively supported by the paired bases to be rotatable about rotation axes. One of the bases abuts against the top surface of the furniture and the other base abuts against the ceiling. As a result, in this overturn preventing device, when the furniture is tilted by shaking of earthquake or the like in a direction parallel to a rotation direction of the damper, the damper is rotated about the rotation axes relative to the bases so that the bases can be maintained in abutment against the top surface of the furniture and the ceiling respectively. As a result, this overturn preventing device can apply a damping force of the damper to the furniture thereby to suppress the tilt of the furniture and prevent the furniture from overturn.

### PRIOR ART DOCUMENT

### Patent Documents

Patent Document 1: Japanese Patent Application Publication No. JP 2015-6330

### SUMMARY OF THE INVENTION

### Problem to be Overcome by the Invention

However, when the shaking of earthquake or the like is multidirectional and the furniture is shaken in a direction intersecting the rotation direction of the damper, the overturn preventing device of Patent Document 1 is not configured to follow the movement of the furniture. Accordingly, there is a possibility that the bases would be detached from the top surface of the furniture or the ceiling when the furniture is shaken in the direction intersecting the rotation direction of the damper. This overturn preventing device cannot prevent the furniture from overturn when the base are detached from the top surface of the furniture or the ceiling and cannot be maintained in a mounted state.

The present invention was made in view of the above-described circumstances in the conventional art and has an object to provide an overturn preventing device which can maintain the mounted state against earthquake or the like with multidirectional shaking and thereby prevent an article from overturn.

### Means for Overcoming the Problem

An overturn preventing device in accordance with the invention includes a damper and a pair of bases. The damper is mounted between a top surface of an article installed on an installation surface and a ceiling. Both ends of the damper are respectively coupled to the bases so as to be swingable in multiple directions. One of the bases abuts against the top surface of the article and the other base abuts against the ceiling.

Both ends of the damper of the overturn preventing device in accordance with the invention may be each formed with circular coupling hole extending therethrough in a direction perpendicular to an axis line extending in an extension/contraction direction of the damper. Furthermore, the bases each may have a shaft member inserted through the coupling hole, and a part thereof inserted through the coupling hole may have a columnar outer shape. The coupling hole has an inner diameter that is larger than an outer diameter of the part of the shaft member inserted through the coupling hole. In this overturn preventing device, the damper is swingable in a direction of a central axis of the shaft member by using a space defined between the coupling hole and the shaft member.

In the overturn preventing device in accordance with the invention, when a pair of the overturn preventing devices are mounted between the top surface of the article and the ceiling, lower ends of the dampers may be located with a predetermined distance therebetween. Furthermore, in a side view as viewed along an imaginary straight line connecting the lower ends of the dampers, upper ends of the dampers may be displaced relative to the lower ends of the dampers in an identical direction rightward or leftward so that the dampers may have respective axis lines inclined in an identical direction. Furthermore, in a front view as viewed from a direction perpendicular to the imaginary straight line connecting the lower ends of the dampers, the upper ends of the dampers may be located between the lower ends of the dampers with a distance therebetween being shorter than the distance between the lower ends of the dampers. The axis lines of the dampers may come closer to each other as the axis lines go upward. In this case, in a front view as viewed from a direction perpendicular to the imaginary line connecting the lower ends of the dampers, the damper come closer to each other as the dampers go upward.

In the overturn preventing device in accordance with the invention, when a pair of the overturn preventing devices are mounted between the top surface of the ceiling, the lower ends of the dampers may be located with a predetermined distance therebetween. Furthermore, in a planar view as viewed from above, the upper ends of the dampers may be located between the lower ends of the dampers at one of two sides across an imaginary line connecting the lower ends of the dampers so that a distance between the upper ends of the dampers is shorter than the distance between the lower ends of the dampers, and the axis lines of the dampers may come closer to each other as the axis lines go upward. Furthermore, in the planar view as viewed from above, the central axes of the shaft members may obliquely intersect with the imaginary straight line connecting the lower ends of the dampers so that a distance between imaginary lines perpendicular to axis lines of the shaft members is increased toward a side where the upper ends of the dampers are located relative to the imaginary line connecting the lower ends of the dampers.

The article includes furniture, book shelves, refrigerators, showcases, server racks, a bed having a plurality of beds connected to each other in the up-down direction, and large sized televisions, and the like all of which have a possibility of being overturned by shaking of earthquake or the

### BRIEF DESCRIPTION OF THE DRAWINGS

FIG. 1 is a side view of the overturn preventing device of one embodiment, mounted between the top surface of the furniture and the ceiling;

FIG. 2 is a front view of the overturn preventing device of the embodiment, mounted between the top surface of the furniture and the ceiling;

FIG. 3 is a partially sectional view of the damper and the base of the overturn preventing device of the embodiment; and

FIG. 4 is a plan view of the overturn preventing device of the embodiment, mounted between the top surface of the furniture and the ceiling.

### BEST MODE FOR CARRYING OUT THE INVENTION

One embodiment of the overturn preventing device in accordance with the present invention will be described with reference to the drawings.

### Embodiment

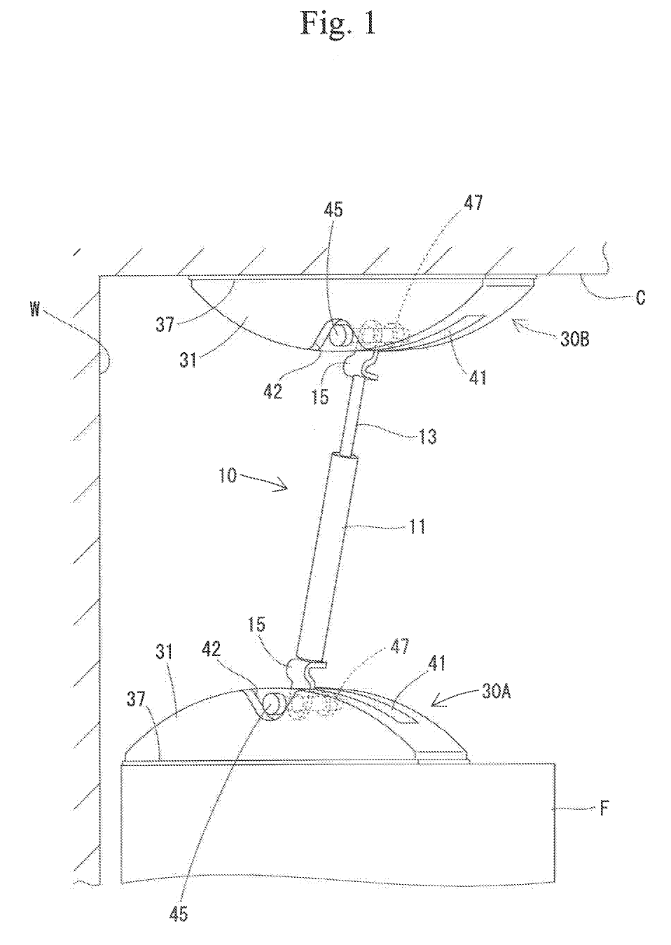

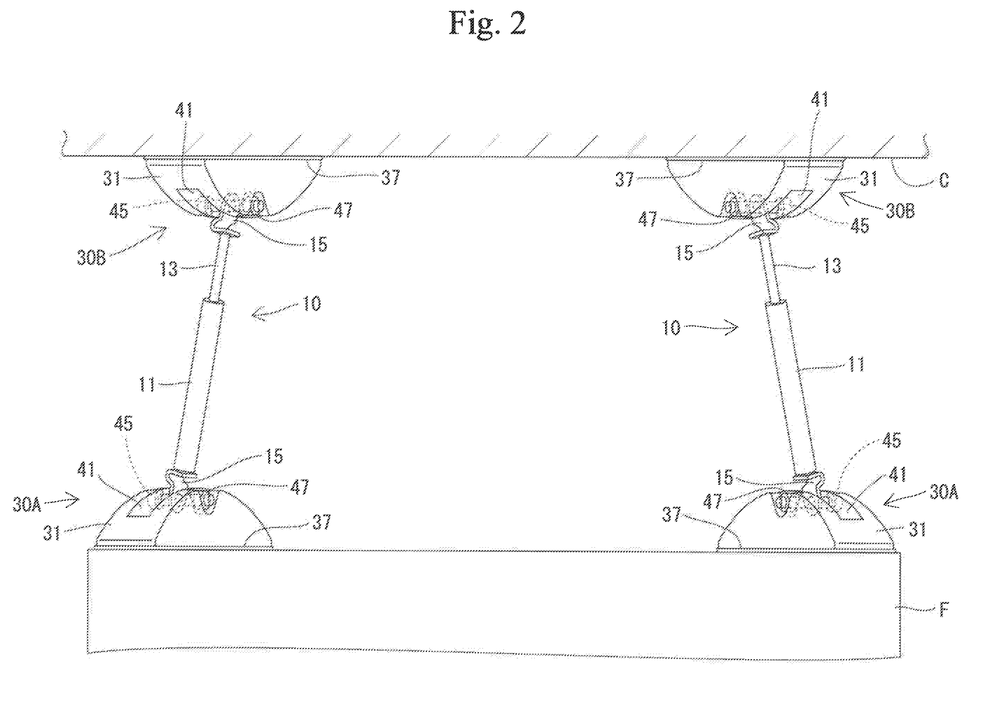

An overturn preventing device of the embodiment is mounted between a top surface of a piece of furniture F and a ceiling C, as illustrated in FIGS. 1 and 2. The furniture F is installed on a floor surface (not illustrated) while a rear surface of the furniture F is opposed to a wall surface W extending in a vertical direction from the floor surface. The furniture F is formed into a rectangular parallelepiped shape and has a door, drawers (neither illustrated) and the like in a front (a right side as viewed in FIG. 1), so that clothes, accessories and the like can be housed in the furniture F. The furniture F has a rectangle-shaped horizontal section long in a right-left direction (a depthwise direction in FIG. 1). When the overturn preventing device is not mounted on the furniture F, the furniture F would possibly be tilted frontward (rightward in FIG. 1) by shaking of earthquake or the like thereby to be overturned.

The overturn preventing device of the embodiment includes a damper 10 and a pair of bases 30A and 30B, as illustrated in FIGS. 1 to 3.

The damper 10 has a cylinder 11, a rod guide (not illustrated), a piston (not illustrated), a rod 13, and two joints 15 respectively provided on both ends of the damper 10. The cylinder 11 is bottomed and has a cylindrical shape. The rod guide closes an opening of the cylinder 11. The piston is slidably inserted in the cylinder 11. The rod 13 has a proximal end connected to the piston. The rod 13 is inserted through the rod guide, so that a distal end thereof protrudes out of the cylinder 11. The cylinder 11 encloses hydraulic fluid and a compression gas.

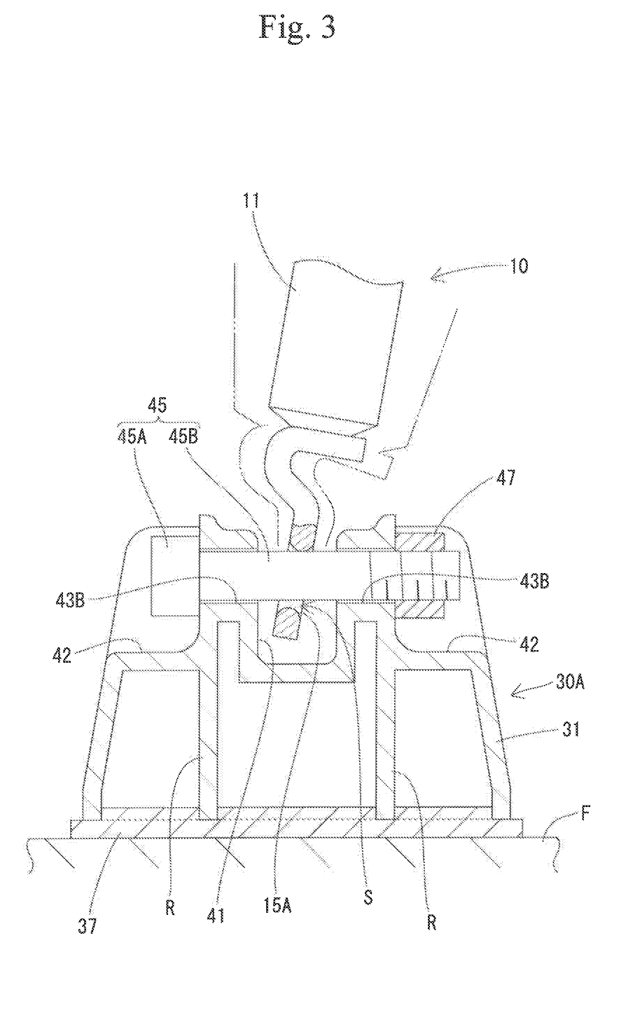

Each joint 15 is formed by bending a flat plate-shaped metal fitting. The joints 15 are respectively connected to a bottom of the cylinder 10 and the distal end of the rod 13. In other words, the joints 15 are respectively connected to both ends of the damper 10. Each joint 15 is formed with a coupling hole 15A as illustrated in FIG. 3. The coupling hole 15A extends through the joint 15 in a direction perpendicular to an axis line of the damper 10 extending in an extension/contraction direction and is circular in shape. The coupling hole 15A has an inner peripheral surface formed into a convexly curved surface so that a thickness-wise middle part of the joint 15 protrudes toward a center of the coupling hole 15A. The coupling hole 15A has an inner diameter that is larger than an outer diameter of a shaft part 45B of a bolt 45 which will be described later.

The damper 10 is a compression damper in which a damping force generated during an extending operation is smaller than a damping force generated during a contracting operation. The extending operation of the damper 10 refers to an operation which increases an amount of protrusion of the rod 13 out of the cylinder 11 and the length of the damper 10. The contracting operation of the damper 10 refers to an operation which reduces an amount of protrusion of the rod 13 out of the cylinder 11 and the length of the damper 10. An expansion force of the compression gas enclosed in the cylinder 11 works in an extension direction of the damper 10.

The following will describe a mechanism of generating a damping force by the damper 10. Since the mechanism has a known structure, diagrammatic representation is eliminated. The cylinder 11 has an interior divided by the piston into a rod side pressure chamber in which the proximal end of the rod 13 is housed and a counter-rod side pressure chamber. The piston is formed with an orifice which is a throttle valve communicating between both pressure chambers. The orifice functions as a damping force generator which applies resistance to a flow of the hydraulic fluid between the rod side pressure chamber and the counter-rod side pressure chamber with the extending/contracting operation of the damper 10. Furthermore, the piston is formed with a communication path communicating with both pressure chambers via a check valve. The check valve allows the hydraulic fluid to flow from the rod side pressure chamber to the counter-rod side pressure chamber and blocks reverse flow of the hydraulic fluid. Accordingly, the damper 10 has two flow paths of the hydraulic fluid from the rod side pressure chamber to the counter-rod side pressure chamber during the extending operation, that is, one flow path including the orifice and the other flow path including the communication path. On the other hand, the damper 10 has only one flow path of the hydraulic fluid from the counter-rod side pressure chamber to the rod side pressure chamber through the orifice during the contracting operation. Accordingly, the damping force generated by the damper 10 during the extending operation is smaller than the damping force generated by the damper 10 during the contracting operation.

The paired bases are a first base 30A and a second base 30B as illustrated in FIGS. 1 and 2. The joint 15 connected to the bottom of the cylinder 11 is coupled to the first base 30A. The joint 15 connected to a distal end of the rod 13 is coupled to the second base 30B. The first base 30A is placed in abutment on the top surface of the furniture F, and the second base 30B is caused to abut against the ceiling C. The first and second bases 30A and 30B have the same form and the same structure. Each of the bases 30A and 30B has a base body 31, a slip preventing part 37, and a bolt 45 and a nut 47 serving as a shaft member, as illustrated in FIGS. 1 to 3.

The base body 31 has a rectangular outer shape in a planar view as viewed from above in a state where the first base 30A is placed in abutment on the top surface of the furniture F (hereinafter, a direction in which a long side in the outer shape of the base body 31 extends in this planar view will be referred to as “a long side direction” and a direction in which a short side extends will be referred to as “a short side direction”). Furthermore, in a side view of the first base 30A as viewed in the short side direction in the state where the first base 30A is placed in abutment on the top surface of the furniture F, the base body 31 has a lower edge which extends straightforward in parallel to the top surface of the furniture F and an upper edge which upwardly bulges from both sides of the lower edge thereby to have an arc-shaped outer shape (refer to FIGS. 1 and 2). Still furthermore, in a side view of the first base 30A as viewed in the long side direction in the state where the first base 30A is placed in abutment on the top surface of the furniture F, the base body 31 has a trapezoidal outer shape in which the upper edge is shorter than the lower edge (refer to FIG. 3).

In the first base 30A placed in abutment on the top surface of the furniture F, the base body 31 has a groove 41 which is formed in an upper surface thereof and extends in the long side direction (a right-left direction as viewed in FIG. 1 and a depthwise direction as viewed in FIGS. 2 and 3). In a side view of the first base 30A as viewed in the long side direction in the state where the first base 30A is placed in abutment on the top surface of the furniture F, the groove 41 is formed in the right-left middle. The groove 41 has a bottom 41A spreading on a horizontal surface and inner wall surfaces 41B respectively rising from both sides of the bottom 41A substantially in a vertical direction. The bottom 41A of the groove 41 extends substantially to a middle of the base body 31 in the up-down direction. The inner wall surfaces 41B rising at both sides of the grove 41 have respective insertion holes 43B which are formed in the middles in the long side direction so as to extend in the short side direction and through which the shaft part 45B of the bolt 45 which will be described later is inserted, as illustrated in FIG. 3.

In the first base 30A placed in abutment on the top surface of the furniture F, the base body 31 has recesses 42 respectively formed in both sides of the groove 41 in the middle in the long side direction. The recesses 42 are each open upward and outward with respect to the short side direction. The insertion holes 43B are each open in the recesses 42. A head 45A of the bolt 45 is housed in one of the recesses 42, and the nut 47 screwed onto the distal end of the shaft 45B of the bolt 45 is hosed in the other recess 42. The recesses 42 are formed to be upwardly spread in the long-side direction so that tools can be fitted with the bolt head 45A and the nut 47 from above.

The base body 31 is hollow as illustrated in FIG. 3. Furthermore, the base body 31 is downwardly open in the first base 30A placed in abutment on the top surface of the furniture F. A plurality of ribs extending in parallel to the short-side direction and two ribs R extending in parallel to the long-side direction are formed in the inside of the base body 31 so as to intersect with each other.

The slip preventing part 37 has an outer shape which is similar to and slightly larger than the outer shape of the base body 31 (a rectangular shape), as illustrated in FIGS. 1 to 3. The slip preventing part 37 is an elastic body. In the first base 30A placed in abutment on the top surface of the furniture F, the slip preventing part 37 is fitted in a lower opening of the base body 31. Furthermore, the slip preventing part 37 is substantially flat in shape. In more detail, in the slip preventing part 37, a surface which abuts against the top surface of the furniture F or the ceiling C is flat, and an oppositely directed surface (the surface opposed to the base body 31) is formed with a fitting groove according to an outer peripheral wall of the base body 31 and the ribs R. The slip preventing part 37 is detachably attached to the base body 31 by an elastic force thereof.

The shaft member is composed of a bolt 45 and a nut 47 as illustrated in FIGS. 1 to 3. The shaft part 45B of the bolt 45 is inserted through one of the insertion holes 43B of the base body 31, and a distal end of the shaft part 45B protrudes out of the other insertion hole 43B. The nut 47 is screwed on a distal end of the shaft part 45B of the bolt 45. The shaft part 45B of the bolt 45 serving as the shaft member is inserted through the coupling hole 15A of the damper 10. The shaft part 45B of the bolt 45 has an outer shape that is columnar. In other words, part of the shaft member inserted through the coupling hole 15A has a columnar outer shape. Since the inner diameter of the coupling hole 15A is larger than the outer diameter of the shaft part 45B as described above, a space S is defined between the coupling hole 15A and the shaft part 45B as illustrated in FIG. 3. Using this space 5, the damper 10 in the overturn preventing device is swingable also in a direction of the central axis of the bolt 45. In other words, both ends of the damper 10 are respectively coupled to the first and second bases 30A and 30B so as to be swingable in multiple directions.

The following will describe a manner of mounting the overturn preventing device between the top surface of the furniture F installed on the floor and the ceiling C with the rear surface of the furniture F being opposed to the wall surface W.

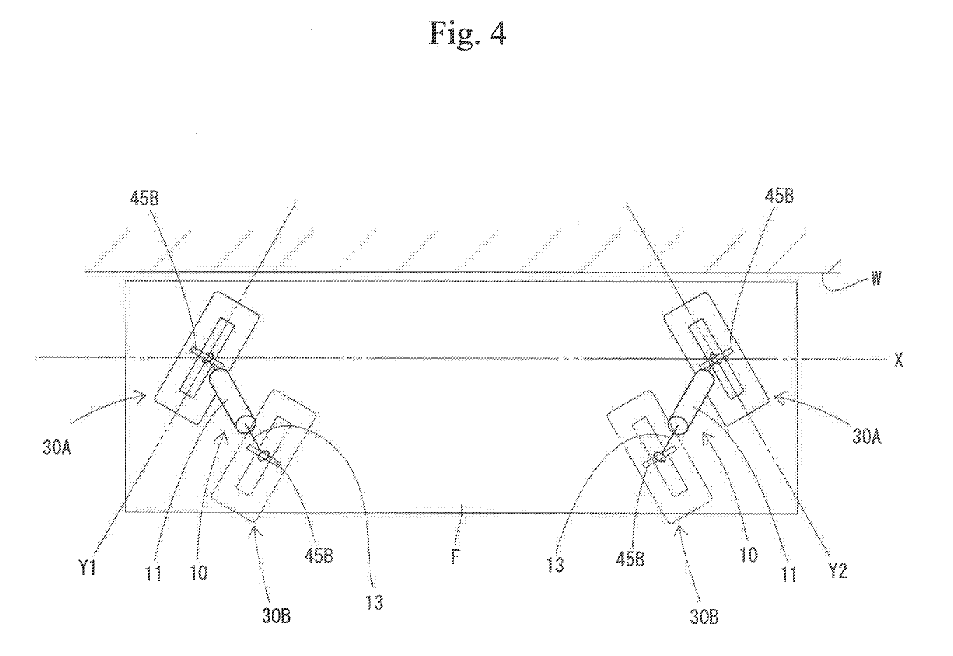

First, the first bases 30A are respectively placed on the wall surface side of both right-left ends of the top surface of the furniture F. In this case, the first bases 30A are each placed obliquely with respect to right and left side edges of the top surface of the furniture F so that a front end of the first base 30A in the long side direction is located horizontally outward as compared with a rear end thereof, as illustrated in FIGS. 2 and 4.

The damper 10 is then extended by the expansion force of the compressed gas enclosed in the cylinder 11 so that the second base 30B is caused to abut against the ceiling C, as illustrated in FIG. 1. In this case, an inclination angle of the axis line of the damper 10 to the vertical direction is set to be between 15° and 25°. Furthermore, the distance between two second bases 30B caused to abut against the ceiling C is set to be shorter than the distance between two first bases 30A placed on the top surface of the furniture F, as illustrated in FIGS. 2 and 4. Thus, the mounting of a pair of overturn preventing devices between the top surface of the furniture F and the ceiling C is completed.

The paired overturn preventing devices mounted between the top surface of the furniture F and the ceiling C will be described in more detail. Two first bases 30A are placed on the top surface of the furniture F with a predetermined distance therebetween, as illustrated in FIGS. 2 and 4. In other words, the lower ends of the dampers 10 of the respective overturn preventing device are located with a predetermined distance therebetween. In a planar view as viewed along an imaginary straight line X connecting the lower ends of the dampers 10 to each other (refer to FIG. 4), the upper ends of the dampers 10 are located farther away from the wall surface W (rightward) than the lower ends of the dampers 10, and the axis lines of the dampers 10 are inclined in an identical direction, as illustrated in FIG. 1. Furthermore, as illustrated in FIG. 2 in a front view as viewed from the direction perpendicular to the imaginary straight line X connecting the lower ends of the dampers 10, the upper ends of the dampers 10 are located between the lower ends of the dampers 10 with the distance therebetween being shorter than the distance between the lower ends of the dampers 10, so that the axis lines come closer to each other as they go upward.

Furthermore, in the pair of the overturn preventing devices mounted between the top surface of the furniture F and the ceiling C, in a planar view as viewed from above as illustrated in FIG. 4, the upper ends of the dampers 10 are located between the lower ends of the dampers 10 at the opposite side to the wall surface W across the imaginary line X connecting the lower ends of the dampers 10 so that a distance between the upper ends of the dampers 10 is shorter than the distance between the lower ends of the dampers 10, and the axis lines of the dampers 10 come closer to each other as they go upward. Furthermore, imaginary lines Y1 and Y2 are perpendicular to the axis lines of the shaft parts 45B of the bolts 45 serving as the shaft members. In a planar view as viewed from above, central axes of the shaft parts 45B of the bolts 45 obliquely intersect with the imaginary straight line X connecting the lower ends of the dampers 10 so that a distance between the imaginary lines Y1 and Y2 is increased toward the side where the upper ends of the dampers 10 are located relative to the imaginary straight line X (in the direction away from the wall surface W).

The overturn preventing device of the embodiment includes the damper 10 and the paired first and second bases 30A and 30B. The damper 10 is mounted between the top surface of the furniture F installed on the floor and the ceiling C. Both ends of the damper 10 are respectively coupled to the first and second bases 30A and 30B so as to be swingable in multiple directions. The first base 30A abuts against the top surface of the furniture F, and the second base 30B abuts against the ceiling C.

Both ends of the damper 10 are respectively coupled to the first and second bases 30A and 30B so as to be swingable in multiple directions. As a result, the damper 10 is swung in multiple directions against shaking of earthquake or the like with multidirectional shaking, with the result that the bases 30A and 30B can respectively be maintained in abutment against the top surface of the furniture F and the ceiling C. Consequently, the overturn preventing device can maintain the bases 30A and 30B in abutment against the top surface of the furniture F and the ceiling C against earthquake or the like with multidirectional shaking and thereby prevent the furniture F from overturn.

Accordingly, the overturn preventing device of the embodiment can maintain the mounted state against earthquake or the like with multidirectional shaking and thereby prevent the furniture F from overturn.

Furthermore, both ends of the damper 10 are respectively formed with circular coupling holes 15A extending therethrough in the direction perpendicular to the axis line extending in the extension/contraction direction of the damper 10. Furthermore, the bases 30A and 30B respectively have the bolts 45 inserted into the coupling holes 15A and including the shaft parts 45B inserted into the coupling holes 15A and having the columnar outer shape. The coupling holes 15A each have the inner diameter that is larger than the outer diameter of the shaft 45B of the bolt 45. In this overturn preventing device, the damper 10 is swingable in the direction of the central axis of the bolt 45 by using the space S defined between the coupling hole 15A and the shaft part 45B of the bolt 45. Thus, the overturn preventing device can render the damper 10 swingable in multiple directions relative to the bases 30A and 30B with a simple coupling structure.

Furthermore, in the overturn preventing device, when the paired overturn preventing devices are mounted between the top surface of the furniture F and the ceiling C, the lower ends of the dampers 10 are located with the predetermined distance therebetween. Furthermore, in the side view as viewed along the imaginary straight line X connecting the lower ends of the dampers 10, the upper ends of the dampers 10 are located farther away from the wall surface W than the lower ends of the dampers 10, and the axis lines of the dampers 10 are inclined in the identical direction. Furthermore, in the front view as viewed from the direction perpendicular to the imaginary straight line X connecting the lower ends of the dampers 10, the upper ends of the dampers 10 are located between the lower ends of the dampers 10 with the distance therebetween being shorter than the distance between the lower ends of the dampers 10, so that the axis lines come closer to each other as they go upward. As a result, the dampers 10 can exert the damping forces also against the shaking in the right-left direction in the front view, so that the bases 30A and 30B can be maintained in abutment against the top surface of the furniture F and the ceiling C with the result that the furniture F can be prevented from overturn.

Furthermore, when the paired overturn preventing devices are mounted between the top surface of the furniture F and the ceiling C, the lower ends of the dampers 10 are located with the predetermined distance therebetween. Furthermore, in the planar view as viewed from above, the upper ends of the dampers 10 are located between the lower ends of the dampers at the opposite side to the wall surface W across the imaginary line X connecting the lower ends of the dampers 10 so that the distance between the upper ends of the dampers 10 is shorter than the distance between the lower ends of the dampers 10, and the axis lines of the dampers 10 come closer to each other as they go upward. Furthermore, in the planar view as viewed from above, imaginary lines Y1 and Y2 are perpendicular to the axis lines of the shaft parts 45B of the bolts 45 serving as the shaft members. In the planar view as viewed from above, the central axes of the shaft parts 45B of the bolts 45 obliquely intersect with the imaginary straight line X connecting the lower ends of the dampers 10 so that the distance between the imaginary lines Y1 and Y2 is increased toward the side where the upper ends of the dampers 10 are located relative to the imaginary straight line X (in the direction away from the wall surface W). As a result, the axis lines of the respective dampers 10 extend obliquely with respect to the central axes of the shaft members of the dampers 10, so that the axis lines of the dampers 10 come closer to each other as they go upward. Consequently, the dampers 10 can exert the damping forces also against the shaking in the right-left direction in the front view as viewed from the direction perpendicular to the imaginary line X connecting the lower ends of the dampers 10, so that the bases 30A and 30B can be maintained in abutment against the top surface of the furniture F and the ceiling C with the result that the furniture F can be prevented from overturn.

The present invention should not be limited to the embodiment described above with reference to the drawings, but the technical scope of the invention encompasses the following embodiments, for example.
(1) Although the overturn preventing device is mounted on the furniture in the embodiment, the overturn preventing device may be mounted on an article such as a bookshelf or a refrigerator which has a possibility of being overturned by shaking of earthquake or the like.
(2) Although the overturn preventing device is mounted on the furniture installed on the floor with the rear surface being opposed to the wall surface in the foregoing embodiment, the overturn preventing device may be mounted on the furniture or the like installed on the floor without being adjacent to the wall surface.
(3) Although the damper is swingable in the direction of the central axis of the bolt by using the space defined between the coupling hole and the shaft part of the bolt in the foregoing embodiment, both ends of the damper may be coupled so as to be swingable in multiple directions by another structure.
(4) Although two overturn preventing devices are mounted between the top surface of the furniture and the ceiling in the foregoing embodiment, only one or three or more overturn preventing devices may be mounted.
(5) Although the compression dampers are used in the foregoing embodiment, the dampers may be two-way dampers as long as each damper can exert a predetermined damping force in a contracting operation.
(6) Although the damper including a cylinder filled with the hydraulic fluid and compressed gas is used in the foregoing embodiment, a fluid-pressure damper using a cylinder filled with another fluid or another type of damper may be used as long as it can exert a predetermined damping force in a contracting operation.
(7) In the foregoing embodiment, the cylinder is filled with the compressed gas so that an expansion force of the compressed gas acts in an extension direction. However, a force acting in the extension direction may be generated in another manner. Furthermore, the cylinder may not be filled with any compressed gas or the like, and no force may act in the extension direction.
(8) The form of each base should not be limited to that in the foregoing embodiment.

### EXPLANATION OF REFERENCE SYMBOLS

C . . . ceiling; F . . . furniture (article); S . . . space; 10 . . . damper; 15A . . . coupling hole; 30A, 30B . . . bases (30A . . . first base, 30B . . . second base); 45, 47 . . . shaft member (45 . . . bolt, 47 . . . nut).

1. An overturn preventing device comprising:
a damper to be mounted between a top surface of an article installed on an installation surface and a ceiling, the damper having two ends; and
a pair of bases to which the ends of the damper are respectively coupled so as to be swingable in multiple directions, one of the bases being configured to abut against the top surface of the article and the other base being configured to abut against the ceiling.

2. The overturn preventing device according to claim 1, wherein:
the ends of the damper are each formed with circular coupling hole extending therethrough in a direction perpendicular to an axis line extending in an extension/contraction direction of the damper;
the bases each have a shaft member inserted through the coupling hole, and a part of the shaft member inserted through the coupling hole has a columnar outer shape;
the coupling hole has an inner diameter that us larger than an outer diameter of the part of the shaft member inserted through the coupling hole; and
the damper is swingable in a direction of central axis of the shaft member by using a space defined between the coupling hole and the shaft member.

3. The overturn preventing device according to claim 1, wherein:
when a pair of the overturn preventing devices are mounted between the top surface of the article and the ceiling, lower ends of the dampers are located with a predetermined distance therebetween;
in a side view as viewed along an imaginary straight line connecting the lower ends of the dampers, upper ends of the dampers are displaced relative to the lower ends of the dampers in an identical direction rightward or leftward so that the dampers have respective axis lines inclined in an identical direction; and
in a front view as viewed from a direction perpendicular to the imaginary straight line connecting the lower ends of the dampers, the upper ends of the dampers are located between the lower ends of the dampers with a distance therebetween being shorter than the distance between the lower ends of the dampers, and the axis lines of the dampers come closer to each other as the axis lines go upward.

4. The overturn preventing device according to claim 2, wherein:
when a pair of the overturn preventing devices are mounted between the top surface of the ceiling, the lower ends of the dampers are located with a predetermined distance therebetween;
in a planar view as viewed from above, the upper ends of the dampers are located between the lower ends of the dampers at one of two sides across an imaginary line connecting the lower ends of the dampers so that a distance between the upper ends of the dampers is shorter than the distance between the lower ends of the dampers, and the axis lines of the dampers come closer to each other as the axis lines go upward; and
the central axes of the shaft members obliquely intersect with the imaginary straight line connecting the lower ends of the dampers so that a distance between imaginary lines perpendicular to the axis lines of the shaft members is increased toward a side where the upper ends of the dampers are located relative to the imaginary line connecting the lower ends of the dampers.

5. The overturn preventing device according to claim 2, wherein:
when a pair of the overturn preventing devices are mounted between the top surface of the article and the ceiling, lower ends of the dampers are located with a predetermined distance therebetween;
in a side view as viewed along an imaginary straight line connecting the lower ends of the dampers, upper ends of the dampers are displaced relative to the lower ends of the dampers in an identical direction rightward or leftward so that the dampers have respective axis lines inclined in an identical direction; and
in a front view as viewed from a direction perpendicular to the imaginary straight line connecting the lower ends of the dampers, the upper ends of the dampers are located between the lower ends of the dampers with a distance therebetween being shorter than the distance between the lower ends of the dampers, and the axis lines of the dampers come closer to each other as the axis lines go upward.
